(19) United States
(12) Patent Application Publication
(10) Pub. No.: US 2011/0226694 A1
(43) Pub. Date: Sep. 22, 2011

(54) METHODS OF REDUCING RADIOTOXICITY IN AQUEOUS ACIDIC SOLUTIONS AND A REACTION SYSTEM FOR SAME

(75) Inventors: Leigh R. Martin, Ammon, ID (US); Nicholas C. Schmitt, Ririe, ID (US); Peter R. Zalupski, Idaho Falls, ID (US); Bruce J. Mincher, Idaho Falls, ID (US)

(73) Assignee: BATTELLE ENERGY ALLIANCE, LLC, Idaho Falls, ID (US)

(21) Appl. No.: 12/728,713

(22) Filed: Mar. 22, 2010

(51) Int. Cl. B01D 11/00; G21C 1/00; C22B 3/00

(52) U.S. Cl. 210/638; 422/159

(57) ABSTRACT

A method of reducing radiotoxicity in an aqueous acidic solution is disclosed. The method comprises oxidizing actinide ions in an aqueous acidic solution to hexavalent actinide ions. An organic phase comprising at least one organophosphorus extractant is added to the aqueous acidic solution. The at least one organophosphorus extractant comprises a compound having from one oxygen atom to three oxygen atoms bonded to a phosphorus atom and having one of the oxygen atoms bonded to the phosphorus atom through a phosphorus-oxygen double bond. Complexes are formed between the hexavalent actinide ions and the at least one organophosphorus extractant. The complexes are separated from the aqueous acidic solution. An additional method and a reaction system for removing actinides from an aqueous acidic solution are also disclosed.

### GOVERNMENT RIGHTS

This invention was made with government support under Contract Number DE-AC07-05ID14517 awarded by the United States Department of Energy. The government has certain rights in the invention.

### TECHNICAL FIELD

Embodiments of the present invention relate to methods of reducing radiotoxicity in aqueous acidic solutions by separating actinides from the aqueous acidic solutions. More specifically, embodiments of the present invention relate to methods of reducing radiotoxicity by oxidizing actinides in the aqueous acidic solutions to a hexavalent oxidation state, forming complexes of the hexavalent actinide ions with an organophosphorus extractant, and removing the complexes. Embodiments of the present invention also relate to a reaction system for reducing the radiotoxicity.

### BACKGROUND

The actinides uranium, neptunium, plutonium, and americium account for a significant portion of the radioactivity or heat load in used nuclear fuel generated by nuclear fuel processing. Isotopes of neptunium, plutonium, and americium dominate the radiation dose of the used nuclear fuel up to 250,000 years after discharge from a nuclear reactor. In addition, disposal of the used nuclear fuel containing these isotopes is expensive and requires vast amounts of storage in geologic repositories. The separation of these actinides can be carried out in many ways, including chromatography, electrophoresis, or ion exchange. However, solvent extraction is currently favored by the nuclear industry for the reprocessing of used nuclear fuel. Currently, several separate technologies are required to complete the separation of these actinides from the used nuclear fuel, such as the UREX, Transuranic Extraction (TRUEX), and TALSPEAK processes.

The main process by which uranium and plutonium are separated from the used nuclear fuel is known as the PUREX process, which is an acronym for Plutonium URanium Extraction. The PUREX process uses tri-n-butyl phosphate (TBP) as an extractant to remove the uranium and plutonium cations from used nuclear fuel that has been dissolved in nitric acid. In the PUREX process, uranium and plutonium are selectively removed from the dissolved used nuclear fuel using TBP dissolved in a hydrocarbon diluent. Plutonium is extracted as the tetravalent ion as this yields far higher distribution values than the extraction of hexavalent plutonium ions. However, the extraction performance of TBP for other actinides decreases across the following series: uranium, neptunium, and plutonium. In addition, TBP is not a sufficiently strong complexant to extract americium from the used nuclear fuel.

Americium separation from a short half life nuclear fission product using ammonium peroxydisulfate and silver nitrate is described in Japanese Application number 06-070408. However, the sulfate anion, which is a decomposition product of the ammonium peroxydisulfate, is a complexant of hexavalent actinides. Therefore, no extraction was observed when americium oxidation and extraction were attempted using ammonium peroxydisulfate as the oxidant and TBP as the extractant. When americium is oxidized using sodium bismuthate as the oxidant, TBP was observed to extract americium, as described in Tributylphosphate Extraction Behavior of Bismuthate-Oxidized Americium, Inorganic Chemistry 2008, 47, 6984-6989. However, when considering the kinetic stability of hexavalent americium, the observed distribution ratios for the americium were too low for this reagent to be commercially viable.

It would be desirable to develop a method for the removal of uranium, neptunium, plutonium, and americium ions from used nuclear fuel using nitric acid concentrations similar to those used in the PUREX process. It would also be desirable to develop a method for the removal of uranium, neptunium, plutonium, and americium ions from used nuclear fuel that uses fewer processing acts. The used nuclear fuel having the uranium, neptunium, plutonium, and americium ions removed would have a lower radiotoxicity or heat load relative to conventional used nuclear fuels that include uranium, neptunium, plutonium, and americium ions.

### BRIEF SUMMARY

An embodiment of the present invention comprises a method of reducing radiotoxicity in an aqueous acidic solution. The method comprises oxidizing actinide ions in an aqueous acidic solution to hexavalent actinide ions. An organic phase comprising at least one organophosphorus extractant is added to the aqueous acidic solution. The at least one organophosphorus extractant comprises a compound having from one oxygen atom to three oxygen atoms bonded to a phosphorus atom and having one of the oxygen atoms bonded to the phosphorus atom through a phosphorus-oxygen double bond. Complexes are formed between the hexavalent actinide ions and the at least one organophosphorus extractant. The complexes are then separated from the aqueous acidic solution.

An embodiment of the present invention comprises another method of reducing radiotoxicity in an aqueous acidic solution. The method comprises removing at least a portion of uranium ions from an aqueous acidic solution comprising uranium ions, neptunium ions, plutonium ions, and americium ions. Sodium bismuthate is added to the aqueous acidic solution to oxidize the neptunium ions, plutonium ions, and americium ions to a hexavalent oxidation state. The aqueous acidic solution is contacted with an organic phase comprising an organophosphorus extractant selected from the group consisting of tributyl phosphine oxide, dibutyl butyl phosphonate, butyl dibutyl phosphinate, and combinations thereof. Complexes form between the hexavalent uranium ions, hexavalent neptunium ions, hexavalent plutonium ions, and hexavalent americium ions and the organophosphorus extractant, which are then separated from the aqueous acidic solution.

A further embodiment of the present invention comprises a reaction system for reducing the radiotoxicity in an aqueous acidic solution. The reaction system comprises an aqueous acidic solution comprising reaction products of neptunium, plutonium, and americium with sodium bismuthate, and an organic phase comprising at least one organophosphorus extractant in a diluent. The at least one organophosphorus extractant comprises a compound having from one oxygen atom to three oxygen atoms bonded to a phosphorus atom and having one of the oxygen atoms bonded to the phosphorus atom through a phosphorus-oxygen double bond.

### BRIEF DESCRIPTION OF THE SEVERAL VIEWS OF THE DRAWINGS

While the specification concludes with claims particularly pointing out and distinctly claiming that which is regarded as the present invention, the advantages of this invention may be more readily ascertained from the following description of the invention when read in conjunction with the accompanying drawings in which:

FIG. 1 is a plot showing the nitric acid dependency for the extraction of hexavalent americium ions with TBP versus dibutyl butyl phosphonate (DBBP); and

FIG. 2 is a plot showing the DBBP dependency for the extraction of hexavalent americium ions at a constant aqueous acidity of 0.1M nitric acid and approximately 22° C.

### DETAILED DESCRIPTION

As used herein, the terms “comprising,” “including,” “containing,” “characterized by,” and grammatical equivalents thereof are inclusive or open-ended terms that do not exclude additional, unrecited elements or method steps, but also include the more restrictive terms “consisting of” and “consisting essentially of” and grammatical equivalents thereof. As used herein, the term “may” with respect to a material, structure, feature or method act indicates that such is contemplated for use in implementation of an embodiment of the invention and such term is used in preference to the more restrictive term “is” so as to avoid any implication that other, compatible materials, structures, features and methods usable in combination therewith should or must be, excluded.

Methods of removing actinide ions from an aqueous acidic solution are disclosed, as is a reaction system for removing the actinide ions from the aqueous acidic solution. The actinide ions to be removed from the aqueous acidic solution are actinide ions capable of achieving a hexavalent oxidation state (+6). The term “hexavalent actinide ions,” as used herein, means and includes an actinide ion in the hexavalent oxidation state, such as hexavalent uranium ions (U⁶⁺), hexavalent neptunium ions (Np⁶⁺), hexavalent plutonium ions (Pu⁶⁺), hexavalent americium ions (Am⁶⁺), or combinations thereof. The actinide ions in the aqueous acidic solution are oxidized to the hexavalent oxidation state, producing the hexavalent actinide ions. The hexavalent actinide ions are simultaneously or concurrently complexed with at least one organophosphorus extractant, producing extractant complexes. By complexing the hexavalent actinide ions with the organophosphorus extractant, a group separation of the hexavalent actinide ions is achieved, while other components, such as actinide ions not capable of achieving a hexavalent oxidation state, lanthanide compounds, or fission products, remain in the aqueous acidic solution.

The aqueous acidic solution including the actinide ions may be an acidic used nuclear fuel solution or dissolved used nuclear fuel. The aqueous acidic solution may be a uranium-based used nuclear fuel dissolved in an aqueous solution of nitric acid. The aqueous acidic solution may include actinide ions, lanthanide ions, and fission products. The actinide ions present in the aqueous acidic solution may include, but are not limited to, uranium, neptunium, plutonium, americium, and combinations thereof. The aqueous acidic solution may have a pH of less than or equal to approximately 2, and may include from approximately 0.01 M nitric acid (“HNO₃”) to approximately 6 M HNO₃, such as from approximately 0.1 M HNO₃ to about 3 M HNO₃. In used nuclear fuels currently being stored at the Idaho National Laboratory, uranium accounts for a majority of the dissolved used nuclear fuel (approximately 95% by mass), while plutonium, neptunium, and americium are minor components. The uranium ions are predominantly present in the +6 oxidation state, the neptunium ions are predominantly present in the +5 oxidation state, the plutonium ions are predominantly present in the +4 oxidation state, and the americium ions are predominantly present in the +3 oxidation state. In the lower oxidation states (2⁺-4⁺), the actinide ions may be present as an “An^{x+}” cation, where “An” refers to an actinide. However, in higher oxidation states (5⁺-6⁺), the cations may exist as a di-oxo species (AnO₂^{x+}).

Before oxidizing the transuranic ions (neptunium, plutonium, and americium ions) in the aqueous acidic solution to the hexavalent oxidation state, a majority of the uranium ions may be removed from the aqueous acidic solution. By way of example, greater than or equal to approximately 95% of the uranium ions may be removed from the aqueous acidic solution by a conventional technique, such as the UREX process, solvent extraction with tributyl phosphate (TBP), electrolytic processing, or oxidative dissolution in carbonate solutions. In one embodiment, approximately 98% of the uranium ions are removed from the aqueous acidic solution.

After removing the uranium ions, an oxidant may be added to the aqueous acidic solution to oxidize the transuranic ions to the hexavalent oxidation state. The oxidant may have sufficient oxidizing strength to oxidize americium ions to the hexavalent oxidation state. By way of example, the oxidant may be sodium bismuthate, which is commercially available from numerous sources, such as Sigma-Aldrich Co. (St. Louis, Mo.). The potential of the Bi³⁺/Bi⁵⁺ redox couple in the aqueous acidic solution has been measured at 2.0 V, which is of sufficient oxidizing strength to oxidize Am³⁺ to Am⁶⁺ (the potential of the Am³⁺/Am⁶⁺ redox couple in acidic solution is 1.68 V). One advantage of using sodium bismuthate as the oxidant is that no decomposition products are produced that are capable of functioning as complexants or reducing agents of the hexavalent actinide ions. Furthermore, since sodium bismuthate is a strong oxidizer, sodium bismuthate may simultaneously oxidize the transuranic ions to the hexavalent oxidation state, which enables a single oxidant to be used. Any uranium ions that remain in the aqueous acidic solution are already present in the hexavalent oxidation state and, therefore, are not oxidized by the oxidant.

To ensure complete oxidation of the transuranic ions to the hexavalent oxidation state, the sodium bismuthate may be added to the aqueous acidic solution at a concentration of from approximately 10 mg oxidant/ml aqueous acidic solution to approximately 40 mg oxidant/ml acidic solution, such as from approximately 15 mg oxidant/ml aqueous acidic solution to approximately 20 mg oxidant/ml acidic solution.

Once the neptunium, plutonium, and americium ions are in the hexavalent oxidation state, the hexavalent actinide ions (uranium (if present), neptunium, plutonium, and americium) may be complexed with the organophosphorus extractant. The oxidation enables the hexavalent actinide ions to complex with the organophosphorus extractant, which may be extracted into a first organic phase, as described below.

The actinide ions capable of achieving a hexavalent oxidation state may also be oxidized using a combination of ozone and the oxidant. For instance, after removing the majority of the uranium ions, as described above, an excess of ozone may be flowed through the aqueous acidic solution to oxidize neptunium and plutonium ions to their hexavalent oxidation states. The oxidant, such as sodium bismuthate, may then be added to the aqueous acidic solution, as described above, to oxidize the americium ions to the hexavalent oxidation state. The hexavalent actinide ions may then be removed from the aqueous acidic solution as described below.

During the oxidation reaction, the aqueous acidic solution may be maintained at a temperature of from approximately 10° C. to approximately 80° C., such as from approximately 25° C. to approximately 40° C. In one embodiment, the oxidation reaction is conducted at room temperature (from approximately 20° C. to approximately 25° C.). The oxidation reaction may be conducted for a time period of from approximately one hour to approximately three hours, such as for approximately two hours. During the oxidation reaction, the aqueous acidic solution may be intermittently or continuously stirred.

Once the actinide ions are in the hexavalent oxidation state, the aqueous acidic solution may be subjected to a liquid-liquid extraction to remove the hexavalent actinide ions, which include any remaining hexavalent uranium ions and the hexavalent transuranic ions. The aqueous acidic solution including the hexavalent actinide ions may correspond to a first aqueous phase, which is contacted with the first organic phase, to extract the hexavalent actinide ions. The first organic phase may include at least one organophosphorus extractant dissolved in a diluent. The organophosphorus extractant may be sufficiently soluble in the first organic phase so that a high concentration of the organophosphorus extractant is achieved. The concentration of the organophosphorus extractant in the first organic phase may also be sufficiently high to effectively remove the hexavalent actinide ions from the aqueous acidic solution. The organophosphorus extractant may also be relatively insoluble in the first aqueous phase.

The organophosphorus extractant may be a compound having the following general chemical structure:

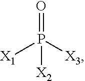

where each of X₁-X₃ is independently selected from an alkyl group, an aryl group, an alkoxy group, an aryloxy group, or combinations thereof, with the exception that X₁-X₃ are not all alkoxy groups or aryloxy groups. The X₁-X₃ groups may also include at least one heteroatom. The organophosphorus extractant may have between one oxygen atom and three oxygen atoms bonded to the phosphorus atom. One of the oxygen atoms is bonded to the phosphorus atom through a phosphorus-oxygen double bond, while each of the three remaining positions on the phosphorus(V) atom are one of the X groups described above. The organophosphorus extractant used to extract the hexavalent actinide ions may have an increased basicity compared to conventional extractants, such as TBP. Without being bound by any particular theory, it is believed that replacing at least one of the butoxy groups of TBP with the alkyl or aryl X groups described above increases the basicity of the phosphoryl oxygen of the organophosphorus extractant. The increased basicity is believed to provide significant improvement to the extraction performance of the method of the present invention.

By way of example, the organophosphorus extractant may be a lipophilic phosphonate compound, a lipophilic phosphinate compound, or a lipophilic phosphine oxide compound, such as a phosphonate compound having the following general chemical structure:

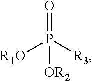

a phosphinate compound having the following general chemical structure:

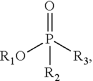

or a phosphine oxide compound having the following general chemical structure

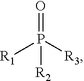

where R₁, R₂, and R₃ are the same or different. R₁, R₂, and R₃ may be straight or branched hydrocarbon chains containing from four carbon atoms to eight carbon atoms. R₁, R₂, and R₃ may also include heteroatoms. In one embodiment, the organophosphorus extractant is tributyl phosphine oxide (TBPO) (chemical formula (C₄H₉)₃PO)

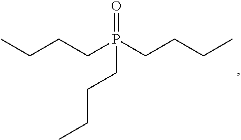

dibutyl butyl phosphonate (DBBP) (chemical formula (C₄H₉)(C₄H₉O)₂PO)

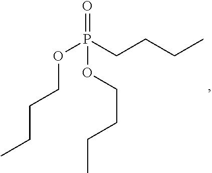

butyl dibutyl phosphinate (B[DBP]) (chemical formula (C₄H₉)₂(C₄H₉O)PO)

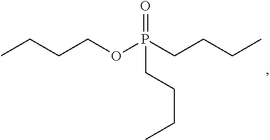

or combinations thereof. TBPO, DBBP, and B[DBP] are commercially available or may be synthesized by conventional organic synthesis techniques, which are not described in detail herein.

The organophosphorus extractant may also be a compound having the following general chemical structure:

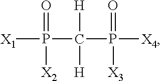

where each of X₁-X₄ is independently selected from the X groups described above. This organophosphorus extractant is a phosphorus-containing compound that includes two phosphorus atoms joined by a methylene spacer. Each phosphorus atom may have between one oxygen atom and three oxygen atoms bonded thereto, with one of the oxygen atoms bonded to the phosphorus atom through a phosphorus-oxygen double bond.

The diluent may be an inert diluent, such as a straight chain hydrocarbon diluent. For instance, the diluent may be an isoparaffinic hydrocarbon diluent, such as Isopar® L or Isopar® M. Isopar® L includes a mixture of C₁₀-C₁₂ isoparaffinic hydrocarbons and is available from Exxon Chemical Co. (Houston, Tex.). Isopar® M includes a mixture of C₁₂-C₁₅ isoparaffinic hydrocarbons and is available from Exxon Chemical Co. (Houston, Tex.). The diluent may also be odorless kerosene, octanol, total petroleum hydrocarbons (TPH), dodecane, or mixtures thereof. As used herein, the term “TPH” means and includes a family of several hundred chemical compounds that originally come from crude oil including, but not limited to, C₈-C₁₂ aliphatic and aromatic hydrocarbon compounds. Odorless kerosene is a mixture of high boiling point, aliphatic hydrocarbon compounds with a high flash point and is a clear water-white liquid, chemically stable and non-corrosive, and virtually odorless. The chemical compounds in the odorless kerosene have a boiling point of from approximately 171.1° C. to approximately 301.1° C. and a flash point of approximately 63° C. In one embodiment, the diluent is dodecane.

To form the first organic phase, the organophosphorus extractant may be dissolved in the diluent at a concentration in the range of from approximately 0.025 M to approximately 2 M, such as from approximately 0.1 M to approximately 1 M. The first organic phase may be produced by combining the organophosphorus extractant with the diluent, with stirring, to form a mixture.

To form extractant complexes with the hexavalent actinide ions, the first aqueous phase may be contacted with at least an equal volume of the first organic phase. However, a greater volume of the first organic phase relative to the first aqueous phase may also be used. Upon contact between the first aqueous phase and the first organic phase, the hexavalent actinide ions (uranium, neptunium, plutonium, and americium ions) may form complexes with the organophosphorus extractant. The extractant complexes may be removed or forward extracted from the first aqueous phase and into the first organic phase while actinide ions not capable of achieving a hexavalent oxidation state, lanthanide ions, and fission products remain in the first aqueous phase. As used herein the terms “forward extract,” “forward extracted,” or “forward extraction” refer to removing or extracting the extractant complexes from the first aqueous phase. The first organic phase and the first aqueous phase may be agitated with one another to forward extract the extractant complexes into the first organic phase. The distribution of the extractant complexes between the first organic phase and the first aqueous phase may heavily favor the first organic phase. The first aqueous phase may be contacted with the first organic phase for an amount of time sufficient to form the extractant complexes between the hexavalent actinide ions and the organophosphorus extractant.

The liquid-liquid extraction may be conducted at a temperature of from approximately 10° C. to approximately 50° C., such as from approximately 10° C. to approximately 30° C. Contact times between the first aqueous phase and the first organic phase may be quick, such as on the order of seconds or minutes. The liquid-liquid extraction may be conducted in a conventional apparatus, such as a centrifugal contactor or a mixer settler. Centrifugal contactors and mixer settlers are known in the art and, therefore, are not described in detail herein.

After contacting the first organic phase and the first aqueous phase for an amount of time sufficient for the extractant complexes to form, the uranium (if present) ions, neptunium ions, plutonium ions, and americium ions may be present in the first organic phase, while the first aqueous phase may be substantially depleted of uranium ions, neptunium ions, plutonium ions, and americium ions. The first organic phase may be enriched in the hexavalent actinide ions, while the first aqueous phase includes any other components of the aqueous acidic solution, such as the fission products, lanthanide ions, and actinide ions that are not capable of achieving a hexavalent oxidation state. The first organic phase and the first aqueous phase may then be separated, effectively removing the hexavalent actinide ions from the aqueous acidic solution.

The distribution of the hexavalent actinide ions between the first organic phase and the first aqueous phase may be determined by conventional techniques. The distribution ratio (“D_{An}”) for a specific actinide is calculated as the ratio of organic phase activity to the aqueous phase activity at equilibrium. The distribution ratio is a measure of the efficiency by which the hexavalent actinide ions are transferred to the first organic phase. High values for the D_{An} indicate that the actinide ions are present in the first organic phase, while low values for the D_{An} indicate that the actinide ions are present the first aqueous phase.

Once separated, the first organic phase and the first aqueous phase may be further processed. For instance, the first aqueous phase may be contacted multiple times with additional volumes of the organophosphorus extractant in the diluent (additional volumes of the first organic phase) to ensure that substantially all of the uranium ions (if present), neptunium ions, plutonium ions, and americium ions are removed from the first aqueous phase. Additional hexavalent actinide ions may be removed from the first aqueous phase with each additional extraction. The first aqueous phase may then be vitrified and disposed of.

The organic phases (the first organic phase and any organic phases generated by subsequent extractions) including the uranium ions (if present), neptunium ions, plutonium ions, and americium ions may be combined. The hexavalent actinide ions may be removed or back extracted from the first organic phase using a second aqueous phase to recover the hexavalent actinide ions. As used herein, the terms “back extract,” “back extracted,” or “back extraction” refer to removing or extracting the uranium ions (if present), neptunium ions, plutonium ions, and americium ions from the first or subsequent organic phases. During recovery and recycling conditions, the distribution of the hexavalent actinide ions between the first organic phase and the second aqueous phase may heavily favor the second aqueous phase. The hexavalent actinide ions may be simultaneously recovered from the first organic phase using a single strip solution as the second aqueous solution. By way of example, the strip solution may be a reducing solution that includes nitric acid and a reductant. The reducing solution may have a nitric acid concentration of from approximately 0.01 M to approximately 0.5 M, such as from approximately 0.1 M to approximately 0.2 M. The reductant may be ferrous sulfamate, a hydroxamic acid, or a uranium(IV) compound, such as uranium(IV) nitrate. If ferrous sulfamate or a hydroxamic acid is used as the reductant, the reductant may be present in the reducing solution at a concentration of from approximately 0.015 M to approximately 0.12 M, such as from approximately 0.03 M to approximately 0.06 M. If a uranium(IV) compound is used as the reductant, the reductant may be present in the reducing solution at a concentration of from approximately 0.5 M to approximately 2 M, such as from approximately 0.8 M to approximately 1.2 M. Multiple strip solutions may also be used to recover the hexavalent actinide ions from the first organic phase. By way of example, the americium ions may be recovered by contacting the first organic phase with a concentrated nitric acid solution, which reduces the hexavalent americium ions to trivalent americium ions. The concentrated nitric acid solution may be an aqueous solution having a nitric acid concentration of from approximately 1 M to approximately 6 M, such as from approximately 3 M to approximately 4 M. The uranium ions, neptunium ions, and plutonium ions may then be recovered by contacting the first organic phase with the reducing solution described above.

The first organic phase may be mixed with the second aqueous phase for an amount of time sufficient for the hexavalent actinide ions to dissociate from the extractant complexes. Once dissociated, the hexavalent actinide ions may be extracted into the second aqueous phase. The second aqueous phase, having substantially all of the uranium, neptunium, plutonium, and americium ions, may be separated from the first organic phase, which is now substantially depleted of the hexavalent actinide ions. The hexavalent actinide ions in the second aqueous phase may then be reused or stored. For instance, the neptunium, plutonium, and americium may be transmutated in a nuclear reactor. By removing the hexavalent actinide ions from the aqueous acidic solution, the heat load and radiotoxicity of the aqueous acidic solution may be reduced. The organophosphorus extractant may also be recovered, such as by subjecting the first organic phase to a solvent washing procedure. By way of example, an alkaline wash solution including approximately 0.1 M sodium carbonate and 0.1 M sodium hydroxide may be used. The recovered organophosphorus extractant may then be reused in subsequent liquid-liquid extractions.

The reaction system for oxidizing the actinides and removing the hexavalent actinide ions may include the aqueous acidic solution, reaction products of the neptunium, plutonium, and americium compounds and the oxidant, and the first organic phase, which includes the organophosphorus extractant and the diluent. Since the majority of the uranium is removed in a first act, and the neptunium, plutonium, americium, and remaining amounts of uranium are removed simultaneously in a second act, the reaction system of the present invention may be advantageous over conventional techniques, which require four or five different separation acts to remove uranium, neptunium, plutonium, and americium. By removing the hexavalent actinide ions, the reaction system may be used to lower the volume and heat load of the aqueous acidic solution. Therefore, the volume of the aqueous acidic solution to be sent to a repository may be reduced. As a result of the reduction in radiotoxicity in the repository, the repository performance models only have to extend to 300 years instead of 250,000 years. In addition, the hexavalent actinide ions and the organophosphorus extractant may be recovered and reused or stored, as described above. Therefore, the reaction system of the present invention may also produce less secondary waste than conventional techniques.

The following examples serve to explain embodiments of the present invention in more detail. These examples are not to be construed as being exhaustive or exclusive as to the scope of this invention.

### EXAMPLES

All chemicals used were reagent grade or higher and were used as received. Ultrapure deionized water (greater than or equal to 18 MΩ) was used to prepare all aqueous acid solutions. The nitric acid was reagent grade and was obtained from Sigma-Aldrich Chemical Co. (St. Louis, Mo.).

### Comparative Example 1

Aqueous nitric acid solutions (concentration range 0.1 M-6 M) were made using ultrapure deionized water. The aqueous nitric acid solutions were spiked with stock solutions that included uranium, neptunium, plutonium, and americium metal ions at a metal concentration of 1×10⁻⁶ M. The neptunium, plutonium, and americium ions were oxidized by adding from 15 mg to 20 mg of sodium bismuthate powder per one ml of the aqueous nitric acid solution. Perchloric acid (0.26 M) was added to the sodium bismuthate-treated, aqueous nitric acid solutions to facilitate increased dissolution of the sodium bismuthate without complexing the uranium, neptunium, plutonium, and americium. TBP was dissolved in dodecane or other similar diluent at a concentration of 0.1 M and was pre-equilibrated and preoxidized for two hours by shaking with the sodium bismuthate-treated, aqueous nitric acid solutions. The TBP/dodecane solution was added to the sodium bismuthate-treated, aqueous nitric acid solutions. The solvent extractions were performed at equal volume and room temperature (20° C.±2° C.) and were of 15 seconds duration.

The aqueous and organic phases were separated by centrifugation for one minute and 10 μl aliquots of each phase were γ-counted using a high purity Ge detector to determine the distribution ratio of americium (D_{Am}) using the Am 74.6 keV gamma line. All solvent extractions were performed in triplicate.

### Example 2

Aqueous nitric acid solutions (concentration range 0.1 M-6 M) were made using ultrapure deionized water. The aqueous nitric acid solutions were spiked with stock solutions that included uranium, neptunium, plutonium, and americium metal ions at a metal concentration of 1×10⁻⁶ M. The neptunium, plutonium, and americium ions were oxidized by adding from 15 mg to 20 mg of sodium bismuthate powder per one ml of the aqueous nitric acid solution. Perchloric acid (0.26 M) was added to the sodium bismuthate-treated, aqueous nitric acid solutions to facilitate increased dissolution of the sodium bismuthate without complexing the uranium, neptunium, plutonium, and americium. DBBP was dissolved in dodecane or other similar diluent at a concentration of 0.1 M and was pre-equilibrated and preoxidized for two hours by shaking with the sodium bismuthate-treated, aqueous nitric acid solutions. The DBBP/dodecane solution was added to the sodium bismuthate-treated, aqueous nitric acid solutions. The solvent extractions were performed at equal volume and room temperature (20° C.±2° C.) and were of 15 seconds duration.

The aqueous and organic phases were separated by centrifugation for one minute and 10 μl aliquots of each phase were γ-counted using a high purity Ge detector to determine the distribution ratio of americium (D_{Am}) using the Am 74.6 keV gamma line. All solvent extractions were performed in triplicate.

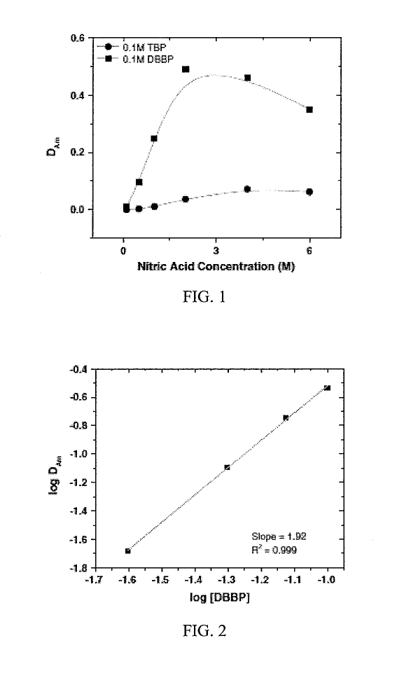

The distribution ratios obtained for the extraction of Am⁶⁺ into 0.1 M DBBP and 0.1 M TBP were plotted as a function of the nitric acid concentration (0.1 M-6 M), as shown in FIG. 1. The D_{Am} for the extraction of Am⁶⁺ into 0.1 M DBBP are shown in filled squares and the D_{Am} for the extraction of Am⁶⁺ into 0.1 M TBP are shown in filled circles. The distribution ratios indicate that by increasing the basicity of the phosphoryl oxygen on the organophosphorus extractant (by using DBBP as the organophosphorus extractant instead of TBP), the metal loading in the organic phase increased. Without being bound to a particular theory, it is believed that the increased basicity of the DBBP results in the formation of a stronger complex between the americium and the DBBP.

### Example 3

Aqueous nitric acid solutions (0.1 M HNO₃) were made using ultrapure deionized water. The aqueous nitric acid solutions were spiked with a stock solution that included americium metal ions at a metal concentration of 1×10⁻⁶ M. The americium was oxidized by adding from 15 mg to 20 mg of sodium bismuthate powder per one ml of the aqueous nitric acid solution. Perchloric acid (0.26 M) was added to the sodium bismuthate-treated, aqueous nitric acid solutions to facilitate increased dissolution of the sodium bismuthate without complexing the americium. DBBP was dissolved in dodecane at a concentration range of from 0.025 M to 0.1 M and was pre-equilibrated and preoxidized for two hours by shaking with the sodium bismuthate-treated, aqueous nitric acid solutions. The DBBP/dodecane solution was added to the sodium bismuthate-treated, aqueous nitric acid solutions. The solvent extractions were performed at equal volume and room temperature (20° C.±2° C.) and were of 15 seconds duration.

The aqueous and organic phases were separated by centrifugation for one minute and 10 μl aliquots of each phase were γ-counted using a high purity Ge detector to determine the D_{Am} using the Am 74.6 keV gamma line. All solvent extractions were performed in triplicate.

The D_{Am} as a function of the DBBP concentrations are shown in FIG. 2, which is a plot of log D_{Am} versus log DBBP concentration. The extraction behavior was determined at a constant nitric acid concentration of 0.1 M. As shown in FIG. 2, the D_{Am} exhibited a linear response to the change in DBBP concentration, the line having a slope of 1.92, which suggests that the DBBP stoichiometry is approximately two and that the extracted complex has a formula of AmO₂(NO₃)₂.2 DBBP.

While the invention may be susceptible to various modifications and alternative forms, specific embodiments have been described in detail herein. However, it should be understood that the invention is not intended to be limited to the particular forms disclosed. Rather, the invention encompasses all modifications, equivalents, and alternatives falling within the scope of the invention as defined by the following appended claims and their legal equivalents.

What is claimed is:

1. A method of reducing radiotoxicity in an aqueous acidic solution, comprising:
oxidizing actinide ions in an aqueous acidic solution to hexavalent actinide ions;
adding an organic phase comprising at least one organophosphorus extractant to the aqueous acidic solution, the at least one organophosphorus extractant comprising a compound having from one oxygen atom to three oxygen atoms bonded to a phosphorus atom and having one of the oxygen atoms bonded to the phosphorus atom through a phosphorus-oxygen double bond;
forming complexes between the hexavalent actinide ions and the at least one organophosphorus extractant; and
separating the complexes from the aqueous acidic solution.

2. The method of claim 1, wherein oxidizing actinide ions in an aqueous acidic solution to hexavalent actinide ions comprises oxidizing neptunium ions, plutonium ions, and americium ions to hexavalent neptunium ions, hexavalent plutonium ions, and hexavalent americium ions.

3. The method of claim 1, wherein oxidizing actinide ions in an aqueous acidic solution to hexavalent actinide ions comprises adding sodium bismuthate to the aqueous acidic solution.

4. The method of claim 1, wherein oxidizing actinide ions in an aqueous acidic solution to hexavalent actinide ions comprises adding from approximately 10 mg of sodium bismuthate per ml of the aqueous acidic solution to approximately 40 mg of sodium bismuthate per ml of the aqueous acidic solution to the aqueous acidic solution.

5. The method of claim 1, wherein oxidizing actinide ions in an aqueous acidic solution to hexavalent actinide ions comprises introducing ozone to the aqueous acidic solution to oxidize neptunium ions and plutonium ions to hexavalent neptunium ions and hexavalent plutonium ions.

6. The method of claim 5, further comprising adding sodium bismuthate to the aqueous acidic solution to oxidize americium ions to hexavalent americium ions.

7. The method of claim 1, wherein adding an organic phase comprising at least one organophosphorus extractant to the aqueous acidic solution comprises adding the organic phase comprising 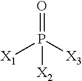
to the aqueous acidic solution, wherein each of X₁-X₃ is independently selected from the group consisting of an alkyl group, an aryl group, an alkoxy group, an aryloxy group, and combinations thereof, except X₁-X₃ are not all alkoxy groups or aryloxy groups

8. The method of claim 1, wherein adding an organic phase comprising at least one organophosphorus extractant to the aqueous acidic solution comprises adding the organic phase comprising a compound selected from the group consisting of: 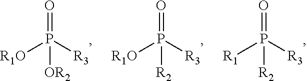
and combinations thereof to the aqueous acidic solution, wherein R₁, R₂, and R₃ are straight or branched hydrocarbon chains containing from four carbon atoms to eight carbon atoms.

9. The method of claim 1, wherein adding an organic phase comprising at least one organophosphorus extractant to the aqueous acidic solution comprises adding the organic phase comprising at least one of tributyl phosphine oxide, dibutyl butyl phosphonate, and butyl dibutyl phosphinate to the aqueous acidic solution.

10. The method of claim 1, further comprising contacting the organic phase with a reducing solution to simultaneously recover the hexavalent actinide ions from the organic phase, the reducing solution comprising nitric acid at a concentration of from approximately 0.01 M to approximately 0.5 M and a reductant selected from the group consisting of ferrous sulfamate, a hydroxamic acid, or a uranium(IV) compound.

11. The method of claim 1, further comprising contacting the organic phase with a concentrated nitric acid solution to recover hexavalent americium ions from the organic phase, the concentrated nitric acid solution comprising from approximately 3 M nitric acid to approximately 4 M nitric acid.

12. The method of claim 11, further comprising contacting the organic phase with a reducing solution to recover hexavalent uranium ions, hexavalent neptunium ions, and hexavalent plutonium ions from the organic phase, the reducing solution comprising nitric acid at a concentration of from approximately 0.01 M to approximately 0.5 M and a reductant selected from the group consisting of ferrous sulfamate, a hydroxamic acid, or a uranium(IV) compound.

13. The method of claim 1, further comprising recovering the at least one organophosphorus extractant.

14. The method of claim 1, wherein separating the complexes from the aqueous acidic solution comprises reducing the radiotoxicity of the aqueous acidic solution.

15. A method of reducing radiotoxicity in an aqueous acidic solution, comprising:
removing at least a portion of uranium ions from an aqueous acidic solution comprising uranium ions, neptunium ions, plutonium ions, and americium ions;
adding sodium bismuthate to the aqueous acidic solution to oxidize the neptunium ions, plutonium ions, and americium ions to a hexavalent oxidation state;
contacting the aqueous acidic solution with an organic phase comprising an organophosphorus extractant selected from the group consisting of tributyl phosphine oxide, dibutyl butyl phosphonate, butyl dibutyl phosphinate, and combinations thereof;
forming complexes between the hexavalent uranium ions, hexavalent neptunium ions, hexavalent plutonium ions, and americium ions and the organophosphorus extractant; and
separating the complexes from the aqueous acidic solution.

16. The method of claim 15, wherein removing at least a portion of uranium ions from an aqueous acidic solution comprising uranium ions, neptunium ions, plutonium ions, and americium ions comprises removing at least 95% of the uranium ions from the aqueous acidic solution.

17. The method of claim 15, wherein adding sodium bismuthate to the aqueous acidic solution comprises adding from approximately 10 mg of sodium bismuthate per ml of the aqueous acidic solution to approximately 40 mg of sodium bismuthate per ml of the aqueous acidic solution to the aqueous acidic solution.

18. A reaction system for removing actinides from an aqueous acidic solution, comprising:
an aqueous acidic solution comprising reaction products of neptunium, plutonium, and americium with sodium bismuthate; and
an organic phase comprising at least one organophosphorus extractant in a diluent, the at least one organophosphorus extractant comprising a compound having from one oxygen atom to three oxygen atoms bonded to a phosphorus atom and having one of the oxygen atoms bonded to the phosphorus atom through a phosphorus-oxygen double bond.

19. The reaction system of claim 18, wherein the reaction products comprise neptunium ions, plutonium ions, and americium ions in a hexavalent oxidation state.

20. The reaction system of claim 19, wherein the at least one organophosphorus extractant is configured to form a complex with the neptunium ions, plutonium ions, and americium ions in a hexavalent oxidation state.

21. The reaction system of claim 18, wherein at least one organophosphorus extractant comprises at least one of tributyl phosphine oxide, dibutyl butyl phosphonate, and butyl dibutyl phosphinate.
